(19) United States
(12) Patent Application Publication
(10) Pub. No.: US 2024/0079640 A1
(43) Pub. Date: Mar. 7, 2024

(54) METHOD FOR PRODUCING SULFIDE SOLID ELECTROLYTE

(71) Applicant: IDEMITSU KOSAN CO.,LTD., Tokyo (JP)

(72) Inventor: Shota Totsuka, Sodegaura-shi (JP)

(73) Assignee: IDEMITSU KOSAN CO.,LTD., Tokyo (JP)

(21) Appl. No.: 18/215,853

(22) Filed: Jun. 29, 2023

(30) Foreign Application Priority Data
Jun. 30, 2022 (JP) 2022-106677

(51) Int. Cl. H01M 10/0562

(52) U.S. Cl. CPC H01M 10/0562; H01M 2300/0068

(57) ABSTRACT

Provided is a method for producing a sulfide solid electrolyte that is superior in productivity and that has a small particle diameter. The method for producing a sulfide solid electrolyte includes mixing a raw material-containing matter that contains a lithium atom, a phosphorus atom, and a sulfur atom with a first solvent to provide a precursor-containing mixture, mixing the precursor-containing mixture with a second solvent that is incompatible with the first solvent to provide an emulsion, and removing the first solvent and the second solvent from the emulsion.

### TECHNICAL FIELD

The present invention relates to a method for producing a sulfide solid electrolyte.

### BACKGROUND ART

With rapid spread of information-related instruments and communication instruments, such as personal computers, video cameras, and mobile phones, in recent years, the development of batteries utilized as power sources therefor has been considered to be important. In the batteries applied to this purpose, an electrolytic solution containing a flammable organic solvent has been used. However, when a battery is fully solidified, no flammable organic solvent is used therein and the safety system is simplified so that the battery is excellent in production cost and productivity. Accordingly, a battery that has a solid electrolyte layer in place of the electrolytic solution is being developed.

As a method for producing a solid electrolyte, PTL 1 discloses a method in which a solution containing solid-electrolyte raw materials and a solvent is supplied into a medium of a high temperature, thereby vaporizing the solvent to precipitate an argyrodite crystal structure.

### CITATION LIST

### Patent Literature

PTL 1: JP 2019-169459 A

### SUMMARY OF INVENTION

### Technical Problem

The present invention has been made in view of the above situation, and has an object to provide a method for producing a sulfide solid electrolyte that is superior in productivity and that has a small particle diameter.

### Solution to Problem

The method for producing a sulfide solid electrolyte according to the present invention is a method for producing a sulfide solid electrolyte, including
mixing a raw material-containing matter that contains a lithium atom, a phosphorus atom, and a sulfur atom with a first solvent to provide a precursor-containing mixture, mixing the precursor-containing mixture with a second solvent that is incompatible with the first solvent to provide an emulsion, and removing the first solvent and the second solvent from the emulsion.

### Advantageous Effects of Invention

According to the present invention, it is possible to provide a method for producing a sulfide solid electrolyte that is superior in productivity and that has a small particle diameter.

### DESCRIPTION OF EMBODIMENTS

An embodiment of the present invention (hereinafter sometimes referred to as “this embodiment”) will be described below. In the description herein, the upper limit values and the lower limit values relating to the numerical ranges accompanied with “or more”, “or less”, and “to”, are numerical values that can be combined in any combination, and the values in the Examples can be used as the upper limit values and the lower limit values. Any of preferred definitions can be adopted. In other words, one preferred definition can be adopted in combination with another preferred definition or other preferred definitions. A combination of preferred definitions is more preferred.

(Findings that the Present Inventor has Acquired to Achieve the Present Invention)

As a result of intensive and extensive studies for solving the above problem, the present inventors have found the following items, thus completing the present invention.

In the method described in PTL 1, a method in which a solution containing solid-electrolyte raw materials and a solvent is supplied to a medium of a high temperature, thereby vaporizing the solvent to precipitate an argyrodite crystal structure is disclosed. However, it is not disclosed that the particle diameter of the resulting solid electrolyte can be reduced by forming an emulsion with two solvents.

It is desired that the sulfide solid electrolyte has a small particle diameter. In a lithium ion battery, the positive electrode material, the negative electrode material, and the electrolyte are all solid. Thus, by reducing the particle diameter of the sulfide solid electrolyte, the contact interfaces between the active materials and the sulfide solid electrolyte are easily formed to improve paths of the ion conduction and the electron conduction.

However, in the method of PTL 1, it is not disclosed to adjust, in particular, to reduce the particle diameter of the resulting solid electrolyte.

In contrast, the present inventors have found that, by mixing a raw material-containing matter with a solvent, and further mixing another solvent therewith to provide an emulsion, and then, removing the solvents, a sulfide solid electrolyte having a small particle diameter can be produced.

### Various Aspects of this Embodiment

A method for producing a sulfide solid electrolyte according to a first aspect of this embodiment is a method for producing a sulfide solid electrolyte, including
mixing a raw material-containing matter that contains a lithium atom, a phosphorus atom, and a sulfur atom with a first solvent to provide a precursor-containing mixture, mixing the precursor-containing mixture with a second solvent that is incompatible with the first solvent to provide an emulsion, and removing the first solvent and the second solvent from the emulsion.

Conventionally, for obtaining a solid electrolyte having a small particle diameter, a method in which a solid electrolyte is subsequently ground with a grinder, such as a bead mill, has been generally used. However, the present invention turned our attention to the formation of an emulsion by using two solvents that are incompatible with each other in combination. The present inventers considered that a sulfide solid electrolyte having a small particle diameter could be produced only by an operation in which a solid electrolyte precursor is formed into an emulsion and then the solvents are removed. If a sulfide solid electrolyte having a small particle diameter could be obtained only by an operation on the solvent, it is quietly efficient from the viewpoint of the production efficiency.

In the production method of this embodiment, the “precursor” refers to a precursor of a solid electrolyte that crystallizes, with heat as required, after removal of a solvent or that crystallizes in a solvent, to provide a sulfide solid electrolyte. The following process is supposed: a raw material-containing matter is sequentially mixed with a first solvent and a second solvent to form an emulsion, whereby solid-electrolyte raw materials are uniformly mixed, and, in some cases, further react with each other to form a precursor having a structure similar to that of the sulfide solid electrolyte; the first solvent and the second solvent are removed therefrom, optionally followed by crystallization or crystallization in a solvent, whereby a reaction between the raw materials proceeds to form a sulfide solid electrolyte.

In the production method of this embodiment, the “precursor-containing mixture” is a mixture that contains at least the precursor and the first solvent, and may further contain unreacted raw materials and the like.

A method for producing a sulfide solid electrolyte according to a second aspect of this embodiment is the method for producing a sulfide solid electrolyte of the first aspect in which
one of the first solvent and the second solvent contains an alcohol solvent and the other of the first solvent and the second solvent contains a hydrocarbon solvent having 5 to 40 carbon atoms.

When the first solvent or the second solvent contains an alcohol solvent, the dispersion state of the raw materials is likely to be uniform, and thus, an electrolyte precursor can be more efficiently obtained. As a result, the production efficiency is increased and it becomes possible to easily produce a high-quality sulfide solid electrolyte.

In addition, by using a hydrocarbon solvent having 5 to 40 carbon atoms which is less compatible with the alcohol solvent as the other of the first solvent and the second solvent, an emulsion can be efficiently formed.

A method for producing a sulfide solid electrolyte according to a third aspect of this embodiment is the method for producing a sulfide solid electrolyte of the first or second aspect in which
the first solvent contains a hydrocarbon solvent having 5 to 40 carbon atoms and the second solvent contains an alcohol solvent.

When the first solvent contains a hydrocarbon solvent, solid-electrolyte raw materials are firstly dispersed uniformly in the first solvent, and then, the dispersion is mixed with the second solvent containing an alcohol solvent to form an emulsion. This can suppress a side reaction that possibly occurs due to a prolonged contact time between the precursor and the alcohol solvent. As a result, a sulfide solid electrolyte having a higher ionic conductivity can be easily obtained.

A method for producing a sulfide solid electrolyte according to a fourth aspect of this embodiment is the method for producing a sulfide solid electrolyte of the first to third aspects in which
the first solvent and the second solvent are removed from the emulsion by removing one of the first solvent and the second solvent from the emulsion to provide a slurry containing the sulfide solid electrolyte and removing the other of the first solvent and the second solvent from the slurry.

An example of a specific preferred method for removing the first solvent and the second solvent from the emulsion containing the first solvent and the second solvent is a stepwise method in which one of the solvents is first removed and then, the other is removed. By such a method, the solvents are easily removed and a sulfide solid electrolyte having a small particle diameter can be efficiently obtained.

A method for producing a sulfide solid electrolyte according to a fifth aspect of this embodiment is the method for producing a sulfide solid electrolyte of the first to third aspects in which
the first solvent and the second solvent are removed from the emulsion by supplying the emulsion into a liquid or gas medium of a temperature higher than a boiling point of the first solvent and higher than a boiling point of the second solvent to vaporize the first solvent and the second solvent.

According to this method, since the first solvent and the second solvent can be removed at almost the same time by supplying the emulsion into a medium held at a high temperature, a sulfide solid electrolyte having a small particle diameter can be efficiently obtained. This method is preferred in this point of view.

A method for producing a sulfide solid electrolyte according to a sixth aspect of this embodiment is the method for producing a sulfide solid electrolyte of the first to fifth aspects in which
the first solvent contains a complexing agent.

A complexing agent as used herein means a compound that can form a complex. When a solvent contains a complexing agent, formation of a complex is promoted and the dispersion state of solid-electrolyte raw materials is easily kept uniform. Thus, all the raw materials contained in the raw material-containing matter easily contribute to the formation of the sulfide solid electrolyte, and as a result, a sulfide solid electrolyte having a higher ionic conductivity is easily obtained.

A method for producing a sulfide solid electrolyte according to a seventh aspect of this embodiment is the method for producing a sulfide solid electrolyte of the first to sixth aspects in which
the raw material-containing matter further contains a halogen atom.

When the raw material-containing matter contains a halogen atom, a sulfide solid electrolyte having a higher ionic conductivity is easily obtained.

A method for producing a sulfide solid electrolyte according to an eighth aspect of this embodiment is the method for producing a sulfide solid electrolyte of the first to seventh aspects, the method further including, after removing the first solvent and the second solvent from the emulsion,
subjecting the sulfide solid electrolyte to a heat treatment to crystallize the sulfide solid electrolyte.

When the sulfide solid electrolyte is subjected to a heat treatment, a crystal structure is formed or the crystallinity thereof is increased (that is, “crystallized”), and thus, a high-quality sulfide solid electrolyte can be obtained.

A method for producing a sulfide solid electrolyte according to a ninth aspect of this embodiment is the method for producing a sulfide solid electrolyte of the first to eighth aspect in which
the first solvent and the second solvent are used at a ratio of 10:90 to 90:10 by mass.

A method for producing a sulfide solid electrolyte according to a tenth aspect of this embodiment is the method for producing a sulfide solid electrolyte of the first to ninth aspects in which
the raw material-containing matter and the first solvent are used at a ratio of 1.0 g or more and 20.0 g or less of the raw material-containing matter relative to 100 ml of the first solvent.

The ratio of the first solvent and the second solvent and the ratio of the raw material-containing matter and the first solvent differ depending on various factors, such as which of the first solvent or the second solvent contains an alcohol solvent, the raw material-containing matter used, and the intended crystal structure of the sulfide solid electrolyte, but, for example, with the ratios within the above ranges, a sulfide solid electrolyte having a small particle diameter can be more efficiently obtained.

A method for producing a sulfide solid electrolyte according to an eleventh aspect of this embodiment is the method for producing a sulfide solid electrolyte of the first to tenth aspects in which
the precursor-containing mixture and the second solvent are mixed at a stirring power of 0.01 W/m³ or more.

In the production method of this embodiment, by increasing the stirring power in forming the emulsion, the droplet diameter of the emulsion can be reduced, and thus, the method is preferred from the viewpoint of further reducing the diameter of the resulting sulfide solid electrolyte.

The stirring power is represented by the following general expression, and can be adjusted by the rotation number and the blade shape.

Stirring power (W/m³)=Np×ρ×n³×d⁵/V
Np: power number (−)
ρ: density (kg/m³)
n: rotation number (rps)
d: wingspan (m)
V: volume (m³)

### (Solid Electrolyte)

The “solid electrolyte” as used herein means an electrolyte that is kept solid at 25° C. in a nitrogen atmosphere. The solid electrolyte in this embodiment is a solid electrolyte that contains a lithium atom, a sulfur atom, and a phosphorus atom and has an ionic conductivity attributable to the lithium atom.

The “solid electrolyte” encompasses both of an amorphous solid electrolyte and a crystalline solid electrolyte.

In the description herein, the crystalline solid electrolyte is a solid electrolyte that has a peak derived from a solid electrolyte observed in an X-ray diffraction pattern in X-ray diffractometry regardless of the presence of a peak derived from a raw material of the solid electrolyte therein. In other words, the crystalline solid electrolyte contains a crystal structure derived from a solid electrolyte, and a part thereof may have a crystal structure derived from the solid electrolyte or the whole thereof may have a crystal structure derived from the solid electrolyte. The crystalline solid electrolyte may contain an amorphous solid electrolyte as a part thereof as long as it has such an X-ray diffraction pattern as above. Accordingly, the crystalline solid electrolyte encompasses a so-called glass ceramic which is obtained by heating an amorphous solid electrolyte to the crystallization temperature or higher.

In the description herein, the amorphous solid electrolyte is a solid electrolyte that shows, in an X-ray diffraction pattern in X-ray diffractometry, a halo pattern in which any peak is substantially not observed except for peaks derived from the materials regardless of the presence of a peak derived from a raw material of the solid electrolyte.

### [Method for Producing a Sulfide Solid Electrolyte]

The method for producing a sulfide solid electrolyte of this embodiment is a method for producing a sulfide solid electrolyte, including
mixing a raw material-containing matter that contains a lithium atom, a phosphorus atom, and a sulfur atom with a first solvent to provide a precursor-containing mixture, mixing the precursor-containing mixture with a second solvent that is incompatible with the first solvent to provide an emulsion, and removing the first solvent and the second solvent from the emulsion.

### [Providing a Precursor-Containing Mixture]

The production method of this embodiment includes mixing a raw material-containing matter that contains a lithium atom, a phosphorus atom, and a sulfur atom with a first solvent to provide a precursor-containing mixture.

Regarding the production method of this embodiment, the raw material-containing matter will be described first.

### (Raw Material-Containing Matter)

The raw material-containing matter used in this embodiment contains a lithium atom, a sulfur atom, and a phosphorus atom, preferably contains a lithium atom, a sulfur atom, a phosphorus atom, and a halogen atom, and more specifically is a containing matter that contains substances containing one or more selected from the group consisting of the above atoms (hereinafter the substances are also referred to as “solid-electrolyte raw materials”). As the halogen atom, a chlorine atom, a bromine atom, or an iodine atom is preferred, and a chlorine atom or a bromine atom is more preferred. The raw material-containing matter preferably contains at least two kinds of halogen atoms.

Typical examples of the raw materials contained in the raw material-containing matter include raw materials constituted of at least two kinds of atoms selected from the above four kinds of atoms, for example, lithium sulfide; lithium halides, such as lithium fluoride, lithium chloride, lithium bromide, and lithium iodide; phosphorus sulfides, such as diphosphorus trisulfide (P₂S₃) and diphosphorus pentasulfide (P₂S₅); and phosphorus halides, such as various phosphorus fluorides (PF₃, PF₅), various phosphorus chlorides (PCl₃, PCl₅, P₂Cl₄), various phosphorus bromides (PBr₃, PBr₅), and various phosphorus iodides (PI₃, P₂I₄); and thiophosphoryl halides, such as thiophosphoryl fluoride (PSF₃), thiophosphoryl chloride (PSCl₃), thiophosphoryl bromide (PSBr₃), thiophosphoryl iodide (PSI₃), thiophosphoryl dichloride fluoride (PSCl₂F), and thiophosphoryl dibromide fluoride (PSBr₂F); and halogen simple substances, such as fluorine (F₂), chlorine (Cl₂), bromine (Br₂), and iodine (I₂), preferably chlorine (Cl₂) and bromine (Br₂).

Examples of a compound that can be used as a raw material other than the above compounds include a raw material that contains at least one kind of atom selected from the four kinds of atoms and also contains an atom other than the four kinds of atoms, more specifically, lithium compounds, such as lithium oxide, lithium hydroxide, and lithium carbonate; alkali metal sulfides, such as sodium sulfide, potassium sulfide, rubidium sulfide, and cesium sulfide; metal sulfides, such as silicon sulfide, germanium sulfide, boron sulfide, gallium sulfide, tin sulfides (SnS, SnS₂), aluminum sulfide, and zinc sulfide; phosphate compounds, such as sodium phosphate and lithium phosphate; halides of an alkali metal other than lithium, for example, sodium halides, such as sodium iodide, sodium fluoride, sodium chloride, and sodium bromide; metal halides, such as an aluminum halide, a silicon halide, a germanium halide, an arsenic halide, a selenium halide, a tin halide, an antimony halide, a tellurium halide, and a bismuth halide; and phosphorus oxyhalides, such as phosphorus oxychloride (POCl₃) and phosphorus oxybromide (POBr₃).

As a raw material contained in the raw material-containing matter, among the above compounds, lithium sulfide, a phosphorus sulfide, such as diphosphorus trisulfide (P₂S₃) or diphosphorus pentasulfide (P₂S₅), a halogen simple substance, such as fluorine (F₂), chlorine (Cl₂), bromine (Br₂), or iodine (I₂), and a lithium halide, such as lithium fluoride, lithium chloride, lithium bromide, or lithium iodide, are preferred. When an oxygen atom is to be introduced into the solid electrolyte, lithium oxide, lithium hydroxide, and a phosphate compound, such as lithium phosphate, are preferred.

As the halogen atom, a chlorine atom, a bromine atom, and an iodine atom are preferred, and the halogen atom is preferably at least one selected from the atoms.

Accordingly, the lithium halide is preferably lithium chloride, lithium bromide, or lithium iodide, and the halogen simple substance is preferably chlorine (Cl₂), bromine (Br₂), or iodine (I₂). One of the above substances can be used alone or two or more thereof can be used in combination.

Preferred examples of a combination of raw materials include a combination of lithium sulfide, diphosphorus pentasulfide, and a lithium halide and a combination of lithium sulfide, diphosphorus pentasulfide, and a halogen simple substance. As the lithium halide, lithium chloride, lithium bromide, and lithium iodide are preferred, and as the halogen simple substance, chlorine, bromine, and iodine are preferred.

In this embodiment, Li₃PS₄ containing a PS₄ structure can be used as a part of the raw materials. Specifically, Li₃PS₄ is provided in advance by production or the like, and is used as a raw material.

The content of Li₃PS₄ in the total of the raw materials is preferably 60 to 100% by mole, more preferably 65 to 90% by mole, and further preferably 70 to 80% by mole.

When Li₃PS₄ and a halogen simple substance are used, the content of the halogen simple substance relative to Li₃PS₄ is preferably 1 to 50% by mole, more preferably 10 to 40% by mole, further preferably 20 to 30% by mole, and furthermore preferably 22 to 28% by mole.

The lithium sulfide used in this embodiment is preferably particles.

The average particle diameter (D₅₀) of the lithium sulfide particles is preferably 0.1 μm or more and 1000 μm or less, more preferably 0.5 μm or more and 100 μm or less, and further preferably 1 μm or more and 20 μm or less. In the description herein, the average particle diameter (D₅₀) is the particle diameter, at which the cumulative amount from the side of the particle having the minimum particle diameter in the particle diameter cumulative curve reaches 50% (by volume) of the total, and the volume distribution can be measured, for example, with a laser diffraction-scattering particle diameter distribution analyzer. Among the raw materials mentioned above, a solid raw material preferably has an average particle diameter that is equivalent to that of the lithium sulfide particles, i.e., preferably within the same range as that of the average particle diameter of the lithium sulfide particles.

When lithium sulfide, diphosphorus pentasulfide, and a lithium halide are used as raw materials, the proportion of lithium sulfide based on the sum of lithium sulfide and diphosphorus pentasulfide is, from the viewpoint of attaining higher chemical stability and higher ionic conductivity, preferably 70 to 82% by mole, more preferably 72 to 80% by mole, and further preferably 74 to 80% by mole.

When lithium sulfide, diphosphorus pentasulfide, and a lithium halide, and another solid-electrolyte raw material used as needed are used, the content of lithium sulfide and diphosphorus pentasulfide based on the sum total thereof is preferably 50 to 100% by mole, more preferably 55 to 85% by mole, and further preferably 60 to 80% by mole.

When lithium chloride and lithium bromide are used in combination as the lithium halide, from the viewpoint of increasing the ionic conductivity, the proportion of lithium chloride based on the sum of lithium chloride and lithium bromide is preferably 1 to 99% by mole, more preferably 10 to 80% by mole, further preferably 20 to 70% by mole, and particularly preferably 25 to 45% by mole.

When a halogen simple substance is used as a raw material and lithium sulfide and diphosphorus pentasulfide are used, the proportion of the moles of lithium sulfide except for lithium sulfide of the same moles as the moles of the halogen simple substance based on the total moles of lithium sulfide and diphosphorus pentasulfide except for lithium sulfide of the same moles as the moles of the halogen simple substance is preferably in the rage of 60 to 90%, more preferably in the range of 65 to 85%, further preferably in the range of 68 to 82%, furthermore preferably in the range of 72 to 78%, and particularly preferably in the range of 73 to 77%. This is because a higher ionic conductivity is obtained with such a proportion.

From the same point of view, when lithium sulfide, diphosphorus pentasulfide, and a halogen simple substance are used, the content of the halogen simple substance based on the total amount of lithium sulfide, diphosphorus pentasulfide, and the halogen simple substance is preferably 1 to 50% by mole, more preferably 2 to 40% by mole, further preferably 3 to 25% by mole, and furthermore preferably 3 to 15% by mole.

When lithium sulfide, diphosphorus pentasulfide, a halogen simple substance, and a lithium halide are used, the content (α % by mole) of the halogen simple substance and the content (β % by mole) of the lithium halide based on the total amount of the above components preferably satisfy the following expression (2), more preferably satisfy the following expression (3), further preferably satisfy the following expression (4), and furthermore preferably satisfy the following expression (5).

2≤2α+β≤100 (2)

4≤2α+β≤80 (3)

6≤2α+β≤50 (4)

6≤2α+β≤30 (5)

When two kinds of halogen are used as the simple substance, with the number of moles of one halogen atom in the substance being taken as A1 and the number of moles of the other halogen atom in the substance as A2, A1:A2 is preferably 1 to 99:99 to 1, more preferably 10:90 to 90:10, further preferably 20:80 to 80:20, and furthermore preferably 30:70 to 70:30.

### (First Solvent)

As the first solvent used in this embodiment, a solvent that has conventionally been used in production of a solid electrolyte can widely be employed, and examples thereof include solvents containing a carbon atom, for example, hydrocarbon solvents, such as an aliphatic hydrocarbon solvent, an alicyclic hydrocarbon solvent, and an aromatic hydrocarbon solvent, an alcohol solvent, an ester solvent, an aldehyde solvent, a ketone solvent, an ether solvent, and a solvent having a carbon atom and a heteroatom. A solvent may be appropriately selected therefrom and used.

More specific examples thereof include aliphatic hydrocarbon solvents, such as hexane, pentane, 2-ethylhexane, heptane, octane, decane, undecane, dodecane, and tridecane; alicyclic hydrocarbon solvents, such as cyclohexane and methylcyclohexane; aromatic hydrocarbon solvents, such as benzene, toluene, xylene, mesitylene, ethylbenzene, tert-butylbenzene, trifluoromethylbenzene, nitrobenzene, chlorobenzene, chlorotoluene, and bromobenzene; alcohol solvents, such as ethanol and butanol; aldehyde solvents, such as formaldehyde, acetaldehyde, and dimethylformamide; ketone solvents, such as acetone and methyl ethyl ketone; ether solvents, such as dibutyl ether, cyclopentyl methyl ether, tert-butyl methyl ether, and anisole; and solvents containing a carbon atom and a heteroatom, such as acetonitrile, dimethylsulfoxide, and carbon disulfide.

Among the solvents, an aliphatic hydrocarbon solvent, an alicyclic hydrocarbon solvent, an aromatic hydrocarbon solvent, an ether solvent, and an alcohol solvent are preferred.

As the first solvent, one of the solvent components may be used alone or two or more of the solvent components may be used in combination.

From the viewpoint of promoting the reaction of the solid-electrolyte raw materials, the first solvent used in this embodiment preferably contains an alcohol solvent and a complexing agent. On the other hand, from the viewpoint of improving the ionic conductivity of the resulting sulfide solid electrolyte while promoting the reaction of the solid-electrolyte raw materials, the first solvent preferably contains a complexing agent and a hydrocarbon solvent.

### (Alcohol Solvent)

Specific examples of the alcohol solvent include primary and secondary aliphatic alcohols, such as methanol, ethanol, isopropanol, butanol, and 2-ethylhexyl alcohol; polyhydric alcohols, such as ethylene glycol, propylene glycol, butanediol, and hexanediol; alicyclic alcohols, such as cyclopentanol, cyclohexanol, and cyclopentylmethanol; aromatic alcohols, such as butylphenol, benzyl alcohol, phenethyl alcohol, naphthol, and diphenylmethanol; and alkoxy alcohols, such as methoxyethanol, propoxyethanol, and butoxyethanol.

As the alcohol solvent, among the above solvents, aliphatic alcohols are preferred, primary aliphatic alcohols are more preferred, methanol and ethanol are further preferred, and ethanol is particularly preferred.

### (Hydrocarbon Solvent)

As mentioned above, examples of the hydrocarbon solvent include an aliphatic hydrocarbon solvent, an alicyclic hydrocarbon solvent, and an aromatic hydrocarbon solvent. One or two selected from therefrom can be used, but it is preferred to use solvents selected from aliphatic hydrocarbon solvents.

Regarding the number of carbon atoms of the hydrocarbon solvent, it is preferred to use a hydrocarbon solvent having 5 to 40 carbon atoms which is less compatibility with an alcohol solvent, it is more preferred to use a hydrocarbon solvent having 6 to 30 carbon atoms, and it is further preferred to use a hydrocarbon solvent having 7 to 20 carbon atoms.

The first solvent used in this embodiment preferably contains as a part thereof a complexing agent as described below.

### (Complexing Agent)

A complexing agent is a compound that easily forms a complex with a solid-electrolyte raw material contained in the raw material-containing matter, as described above, and is a compound that can form a complex, for example, with sulfide lithium and diphosphorus pentasulfide which are preferably used as solid-electrolyte raw materials, with Li₃PS₄ which is obtained when the sulfide lithium and diphosphorus pentasulfide are used, and further with a solid-electrolyte raw material containing a halogen atom (hereinafter, these substances are also collectively referred to as “solid-electrolyte raw materials, etc.”).

As the complexing agent, any compound that has the property as described above can be used with no particular limitation, and, in particular, a compound containing an atom having high affinity to a lithium atom, for example, a heteroatom, such as a nitrogen atom, an oxygen atom, or a chlorine atom, is preferred, and a compound having a group containing such a heteroatom is more preferably exemplified. This is because such a heteroatom and a group containing such a heteroatom can coordinate on (bind to) lithium.

It is considered that the heteroatom present in the molecule of the complexing agent has high affinity to the lithium atom and thus, the complexing agent has a property of easily binding to the solid-electrolyte raw materials, etc. to form a complex (hereinafter also referred to simply as “complex”). Thus, it is considered that a complex is formed by mixing the solid-electrolyte raw materials with the complexing agent and the dispersion state of the solid-electrolyte raw materials, in particular, the dispersion state of halogen atoms is more easily kept uniform, resulting in a sulfide solid electrolyte having a high ionic conductivity.

The fact that the complexing agent can form a complex with the solid-electrolyte raw materials, etc. is directly confirmed, for example, by an infrared absorption spectrum measured by FT-IR analysis (a diffuse reflectance method).

In the production method of this embodiment, as the complexing agent, a compound containing an oxygen atom as the heteroatom is preferred.

As a compound containing an oxygen atom, a compound that has, as a group containing an oxygen atom, one or more functional groups selected from an ether group and an ester group is preferred, and among them, a compound having an ether group is particularly preferred. That is, as a complexing agent containing an oxygen atom, an ether compound is particularly preferred.

Examples of the ether compound include ether compounds, such as an aliphatic ether, an alicyclic ether, a heterocyclic ether, and an aromatic ether, and one of the ether compounds can be used alone or two or more thereof can be used in combination.

More specific examples of the aliphatic ether include monoethers, such as dimethyl ether, diethyl ether, diisopropyl ether, dibutyl ether, and tert-butyl methyl ether; diethers, such as dimethoxymethane, dimethoxyethane, diethoxymethane, and diethoxyethane; polyethers having three or more ether groups, such as diethylene glycol dimethyl ether (diglyme) and triethylene oxide glycol dimethyl ether (triglyme); and ethers containing a hydroxy group, such as diethylene glycol and triethylene glycol.

The number of carbon atoms of the aliphatic ether is preferably 2 or more, more preferably 3 or more, and further preferably 4 or more, and the upper limit thereof is preferably 10 or less, more preferably 8 or less, and further preferably 6 or less.

The number of carbon atoms of the aliphatic hydrocarbon group in the aliphatic ether is preferably 1 or more, and the upper limit thereof is preferably 6 or less, more preferably 4 or less, and further preferably 3 or less.

Examples of the alicyclic ether include ethylene oxide, propylene oxide, tetrahydrofuran, tetrahydropyran, dimethoxytetrahydrofuran, cyclopentyl methyl ether, dioxane, and dioxolane. Examples of the heterocyclic ether include furan, benzofuran, benzopyran, dioxene, dioxine, morpholine, methoxyindole, and hydroxymethyldimethoxypyridine.

The numbers of carbon atoms of the alicyclic ether and the heterocyclic ether are preferably 3 or more, and more preferably 4 or more. The upper limit thereof is preferably 16 or less, and more preferably 14 or less.

Examples of the aromatic ether include methyl phenyl ether (anisole), ethyl phenyl ether, dibenzyl ether, diphenyl ether, benzyl phenyl ether, and naphthyl ether.

The number of carbon atoms of the aromatic ether is preferably 7 or more, and more preferably 8 or more. The upper limit thereof is preferably 16 or less, more preferably 14 or less, and further preferably 12 or less.

The ether compound used in this embodiment may be one substituted with a substituent, such as an alkyl group, an alkenyl group, an alkoxy group, a hydroxy group, or a cyano group, or a halogen atom.

Among the ether compounds, from the viewpoint of attaining a higher ionic conductivity, an aliphatic ether is preferred, and dimethoxyethane or tetrahydrofuran is more preferred.

Examples of the ester compound include ester compounds, such as an aliphatic ester, an alicyclic ester, a heterocyclic ester, and an aromatic ester, and one of the ester compounds can be used alone or two or more thereof can be used in combination.

More specific examples of the aliphatic ester include formic acid esters, such as methyl formate, ethyl formate, and triethyl formate; acetic acid esters, such as methyl acetate, ethyl acetate, propyl acetate, isopropyl acetate, butyl acetate, and isobutyl acetate; propionic acid esters, such as methyl propionate, ethyl propionate, propyl propionate, and butyl propionate; oxalic acid esters, such as dimethyl oxalate and diethyl oxalate; malonic acid esters, such as dimethyl malonate and diethyl malonate; and succinic acid esters, such as dimethyl succinate and diethyl succinate.

The number of carbon atoms of the aliphatic ester is preferably 2 or more, more preferably 3 or more, and further preferably 4 or more. The upper limit thereof is preferably 10 or less, more preferably 8 or less, and further preferably 7 or less. The number of carbon atoms of the aliphatic hydrocarbon group in the aliphatic ester is preferably 1 or more, and more preferably 2 or more. The upper limit thereof is preferably 6 or less, more preferably 4 or less, and further preferably 3 or less.

Examples of the alicyclic ester include methyl cyclohexanecarboxylate, ethyl cyclohexanecarboxylate, dimethyl cyclohexanedicarboxylate dibutyl cyclohexanedicarboxylate, and dibutyl cyclohexenedicarboxylate. Examples of the heterocyclic ester include methyl pyridinecarboxylate, ethyl pyridinecarboxylate, propyl pyridinecarboxylate, methyl pyrimidinecarboxylate, ethyl pyrimidinecarboxylate, and lactones, such as acetolactone, propiolactone, butyrolactone, and valerolactone.

The numbers of carbon atoms of the alicyclic ester and the heterocyclic ester are preferably 3 or more, and more preferably 4 or more. The upper limit thereof is preferably 16 or less, and more preferably 14 or less.

Examples of the aromatic ester include benzoic acid esters, such as methyl benzoate, ethyl benzoate, propyl benzoate, and butyl benzoate; phthalic acid esters, such as dimethyl phthalate, diethyl phthalate, dibutyl phthalate, butyl benzyl phthalate, and dicyclohexyl phthalate; and trimellitic acid esters, such as trimethyl trimellitate, triethyl trimellitate, tripropyl trimellitate, tributyl trimellitate, and trioctyl trimellitate.

The number of carbon atoms of the aromatic ester is preferably 8 or more, and more preferably 9 or more. The upper limit thereof is preferably 16 or less, more preferably 14 or less, and further preferably 12 or less.

The ester compound used in this embodiment may be one substituted with a substituent, such as an alkyl group, an alkenyl group, an alkoxy group, a hydroxy group, or a cyano group, or a halogen atom.

Among the ester compounds, from the viewpoint of attaining a higher ionic conductivity, an aliphatic ester is preferred, an acetic acid ester is more preferred, and ethyl acetate is particularly preferred.

When the first solvent contains a complexing agent and an alcohol solvent, the ratio of the complexing agent in the first solvent is, as the volume ratio of the complexing agent based on the total volume of the first solvent, preferably 1.0 to 50% by volume, more preferably 5.0 to 40% by volume, and further preferably 10 to 30% by volume.

The ratio of the alcohol solvent in the first solvent is, as the volume ratio of the alcohol solvent based on the total volume of the first solvent, preferably 50 to 99% by volume, more preferably 60 to 95% by volume, and further preferably 70 to 90% by volume.

The ratio of the sum amount of the complexing agent and the alcohol solvent in the first solvent is, as a volume ratio based on the total volume of the first solvent, preferably 50 to 100% by volume, more preferably 70 to 100% by volume, and further preferably 90 to 100% by volume.

On the other hand, when the first solvent contains a complexing agent and a hydrocarbon solvent, the ratio of the complexing agent in the first solvent is, as the volume ratio of the complexing agent based on the total volume of the first solvent, preferably 1.0 to 50% by volume, more preferably 5.0 to 40% by volume, and further preferably 10 to 30% by volume.

The ratio of the hydrocarbon solvent in the first solvent is, as the volume ratio of the hydrocarbon solvent based on the total volume of the first solvent, preferably 50 to 99% by volume, more preferably 60 to 95% by volume, and further preferably 70 to 90% by volume.

The ratio of the sum amount of the complexing agent and the hydrocarbon solvent in the first solvent is, based on the total volume of the first solvent, preferably 50 to 100% by volume, more preferably 70 to 100% by volume, and further preferably 90 to 100% by volume.

The ratio of the first solvent and the second solvent is, from the viewpoint of efficiently forming an emulsion, as the mass ratio (the mass ratio of the first solvent:the mass ratio of the second solvent), preferably 10:90 to 90:10, more preferably 20:80 to 80:20, and further preferably 30:70 to 70:30.

### (Mixing)

In the production method of this embodiment, the aforementioned raw material-containing matter and the first solvent are mixed to provide a precursor-containing mixture.

The ratio of the raw material-containing matter and the first solvent herein is, from the viewpoint of providing a sulfide solid electrolyte having a small particle diameter, preferably 1.0 g or more and 20.0 g or less, more preferably 1.5 g or more and 15.0 g or less, and further preferably 2.0 g or more and 12.0 g or less of the raw material-containing matter relative to 100 ml of the first solvent.

There is no particular limitation in the method for mixing the raw material-containing matter and the first solvent, and the raw material-containing matter and the first solvent may be charged and mixed in an apparatus that can mix the raw material-containing matter and the solvent.

However, when a halogen simple substance is used as a solid-electrolyte raw material, the solid-electrolyte raw material is sometimes not solid. Specifically, fluorine and chlorine are gas whereas bromine is liquid under a normal temperature and a normal pressure. In such a case, for example, when a solid-electrolyte raw material is liquid, the solid-electrolyte raw material may be supplied into a vessel together with the solvent separately from the other solid-electrolyte raw materials in a solid form. When a solid-electrolyte raw material is gas, the solid-electrolyte raw material may be supplied by being blown into the solvent having a solid-electrolyte raw material in a solid form added therein.

The production method of this embodiment is characterized by including mixing the raw material-containing matter with the first solvent. Here, the mixing can be achieved by a method without a machine to be used for the purpose of grinding solid-electrolyte raw materials, which is generally referred to as a grinder, for example, a medium-type grinder, such as a ball mill or a bead mill, to provide a mixture containing a precursor of a solid electrolyte (precursor-containing mixture).

Note that, in mixing or after mixing the raw material-containing matter and the first solvent, the mixture may be ground with a grinder in order to reduce the mixing time for providing a precursor or refining the powder.

An example of an apparatus for mixing the raw material-containing matter and the first solvent is a mechanical stirring mixer having a stirring blade in a vessel. Examples of the mechanical stirring mixer include a high-speed stirring mixer and a double-arm mixer, and from the viewpoint of increasing uniformity of the solid-electrolyte raw materials in the mixture of the solid-electrolyte raw materials and the solvent to attain a higher ionic conductivity, a high-speed stirring mixer is preferably used. Examples of the high-speed stirring mixer include a vertical axis rotating mixer and a horizontal axis rotating mixer, and either type of a mixer may be used.

Examples of the shape of the stirring blade used in the mechanical stirring mixer include an anchor shape, a blade shape, an arm shape, a ribbon shape, a multistage blade shape, a dual arm shape, a shovel shape, a twin screw blade shape, a flat blade shape, and a C-blade shape. From the viewpoint of increasing the uniformity of the solid-electrolyte raw material to attain a higher ionic conductivity, a shovel shape, a flat blade shape, or a C-blade shape is preferred. In the mechanical stirring mixer, a circulation line in which the substance to be stirred is once discharged outside the mixer and is then returned again inside the mixer may be introduced. Thus, a raw material having a high specific gravity is stirred without being settled or retained, whereby more uniform mixing can be applied.

The installation position of the circulation line is not particularly limited, but the circulation line is preferably installed at such a position that the substance is discharged from the bottom of the mixer and is returned into the upper part of the mixer. Thus, a solid-electrolyte raw material that is liable to settle is more easily uniformly stirred by allowing it to ride on the convective flow by circulation. Furthermore, a return port is preferably positioned below the liquid surface of the substance to be stirred. Thus, the liquid to be stirred can be prevented from splashing to attach to the inner wall surface of the mixer.

The temperature condition in mixing the solid-electrolyte raw materials and the first solvent is not particularly limited, and is, for example, −30 to 100° C., preferably −10 to 50° C., and more preferably about a room temperature (23° C.) (for example, room temperature ±5° C.). The mixing time is about 0.1 to 150 hours, and from the viewpoint of more uniformly mixing to attain a higher ionic conductivity, is preferably 1 to 120 hours, more preferably 4 to 100 hours, and further preferably 8 to 80 hours.

When a complexing agent is used as the first solvent, a complex is formed with the solid-electrolyte raw materials, etc. and the complexing agent by mixing the solid-electrolyte raw materials and the complexing agent. More specifically, it is considered that, in the complex, a lithium atom, a sulfur atom, a phosphorus atom, and a halogen atom contained in the solid-electrolyte raw materials bind to each other via the complexing agent and/or directly without intermediation of the complexing agent by the action of the complexing agent and the atoms. In other words, in the production method of this embodiment, a complex obtained by mixing solid-electrolyte raw materials and a complexing agent is composed of the complexing agent, a lithium atom, a sulfur atom, a phosphorus atom, and a halogen atom.

Since the complex obtained in this embodiment is not completely dissolved in the complexing agent which is liquid, and is generally solid, the complex is obtained in the form of a suspension in which the complex is suspended in the solvent containing the complex.

[Mixing the Precursor-Containing Mixture with a Second Solvent]

The production method of this embodiment includes
mixing the precursor-containing mixture with a second solvent that is incompatible with the first solvent to provide an emulsion.

By mixing the precursor-containing mixture and a second solvent to form an emulsion, the precursor contained in the precursor-containing mixture dispersed in the emulsion is scattered in an island form all over the emulsion, and thus, a sulfide solid electrolyte obtained after removal of the first solvent and the second solvent as described later has a small particle diameter even without a subsequent grinding treatment.

### (Second Solvent)

As described above, the second solvent used in this embodiment is required to be incompatible with the first solvent, and thus, it is possible to form an emulsion by mixing the precursor-containing mixture containing the first solvent with the second solvent.

Details of the solvents that can be selected as the second solvent are the same as those mentioned as the first solvent, provided that the second solvent is required to be incompatible with the solvent selected as the first solvent, as described above.

An example of the combination of the first solvent and the second solvent is a combination of one of the first solvent and the second solvent containing an alcohol solvent and the other containing a hydrocarbon solvent having 5 to 40 carbon atoms, and more specific examples include the following aspects (1) to (4):
(1) the first solvent containing an alcohol solvent and the second solvent containing a hydrocarbon solvent having 5 to 40 carbon atoms.
(2) the first solvent containing a hydrocarbon solvent having 5 to 40 carbon atoms and the second solvent containing an alcohol solvent.
(3) the first solvent containing a complexing agent and an alcohol solvent and the second solvent containing a hydrocarbon solvent having 5 to 40 carbon atoms.
(4) the first solvent containing a complexing agent and a hydrocarbon solvent having 5 to 40 carbon atoms and the second solvent containing an alcohol solvent.

In the aspects (1) to (4), in (1) and (3) in which the first solvent contains an alcohol solvent, there is an advantage in that a reaction between solid-electrolyte raw materials easily proceeds. On the other hand, in (2) and (4) in which the second solvent contains an alcohol solvent, there is an advantage in that the contact time between the precursor and the alcohol solvent is short and thus, a side reaction hardly occurs.

In (3) and (4) in which the first solvent contains a complexing agent, the formation of a complex is promoted in the precursor and the dispersion state of the solid-electrolyte raw materials becomes uniform, and thus, a sulfide solid electrolyte having a higher ionic conductivity is easily provided.

In mixing the precursor-containing mixture with the second solvent, it is preferred to apply stronger stirring to more uniformly disperse the precursor in the emulsion. Specifically, the stirring power is preferably 0.010 W/m³ or more, more preferably 1.00 W/m³ or more, and further preferably 10.0 W/m³ or more.

### [Removing the First Solvent and the Second Solvent]

The production method of this embodiment includes
removing the first solvent and the second solvent from the emulsion.

Specific examples of the method for removing the first solvent and the second solvent from the emulsion include the following aspect (1) stepwise removal and aspect (2) collective removal.
(1) One of the first solvent and the second solvent is removed from the emulsion to provide a slurry containing the sulfide solid electrolyte, and the other of the first solvent and the second solvent is removed from the slurry.
(2) The emulsion is supplied into a liquid or gas medium of a temperature higher than the boiling point of the first solvent and higher than the boiling point of the second solvent, thereby vaporizing the first solvent and the second solvent to remove the first solvent and the second solvent from the emulsion.

Furthermore, specific examples of the above aspect (1) stepwise removal include the following aspects (1-1) and (1-2).
(1-1) The first solvent is removed from the emulsion to provide a slurry containing a sulfide solid electrolyte, and then, the second solvent is removed from the slurry.
(1-2) The second solvent is removed from the emulsion to provide a slurry containing a sulfide solid electrolyte, and then, the first solvent is removed from the slurry.

In the stepwise removal mentioned above, the first solvent and the second solvent are stepwise removed. Regarding a specific method for removing the first solvent or the second solvent in the first step (specifically, a step of removing the first solvent in the aspect (1-1) and a step of removing the second solvent in the aspect (1-2)), since the solvent is preferably removed while maintaining the dispersion state of the emulsion from the viewpoint of preventing aggregation of the precursor, the removal is preferably performed not by a liquid-liquid separation treatment using a centrifuge but by a drying treatment under a normal or reduce pressure.

The drying treatment may be performed under a room temperature or may be performed with heat using a dryer or the like.

The drying treatment may be performed under any pressure condition, such as under an increased pressure, a normal pressure, or a reduced pressure, but is preferably performed under a normal pressure or a reduced pressure. In particular, in view of drying at a lower temperature, drying is preferably performed under a reduced pressure or under vacuum with a vacuum pump or the like.

Regarding the temperature condition, the drying is simply performed at a temperature of the boiling point of the solvent to be removed or higher. The specific temperature condition cannot be completely specified since it depends on the types of the first solvent and the second solvent used, but the temperature is preferably 5° C. or more, more preferably 10° C. or higher, further preferably 15° C. or higher, furthermore preferably 50° C. or higher, and particularly preferably 100° C. or higher. The upper limit thereof is preferably 250° C. or lower, more preferably 200° C. or lower, and further preferably 150° C. or lower.

The pressure condition is preferably under a normal pressure or a reduced pressure as described above. In the case of under a reduced pressure, the specific pressure is preferably 85 kPa or less, more preferably 80 kPa or less, and further preferably 70 kPa or less. The lower limit thereof may be vacuum (0 Kpa), and in view of the easiness of pressure control, is preferably 1 kPa or more, more preferably 2 kPa or more, and further preferably 3 kPa or more.

When the remaining first solvent or second solvent is removed from the thus obtained slurry, a drying treatment at a higher temperature or under a lower pressure may be applied, but when the first solvent or second solvent remaining in the slurry has a high boiling point, the solvent is preferably removed by solid-liquid separation, such as filtration, centrifugation, or decantation. Furthermore, the thus obtained sulfide solid electrolyte may be washed by repeating addition of a solvent having a low boiling point and removal by solid-liquid separation, and may additionally be subjected to a drying treatment.

In the aspect (2) collective removal, a sulfide solid electrolyte can be produced by removing the first solvent and the second solvent almost at the same time by supplying the emulsion into a medium heated to a high temperature. Accordingly, the aspect (2) is superior in terms of the production efficiency.

(Medium Heated to a Temperature Higher than the Boiling Points of the Solvents)

The medium to be heated to a temperature higher than the boiling points of the first solvent and the second solvent used in the production method of this embodiment may be gas or liquid. When a liquid medium is used, a high-boiling-point liquid medium that has a boiling point higher than those of the solvents is to be used.

A preferred high-boiling-point liquid medium is one that does not react with or does not dissolve the resulting sulfide solid electrolyte in a particle form. Thus, a hydrocarbon compound is preferably used.

As the hydrocarbon compound used as the medium, a compound having a higher boiling point may be selected from the compounds listed above as a solvent that can be used for obtaining the precursor-containing mixture. Preferred examples thereof include those listed as aliphatic hydrocarbon solvents, alicyclic hydrocarbon solvents, and aromatic hydrocarbon solvents, and more preferred examples thereof include those listed as aliphatic hydrocarbon solvents and alicyclic hydrocarbon solvents.

The number of carbon atoms of the high-boiling-point liquid medium is, in view of the tendency to have a boiling point higher than the boiling points of the solvents, preferably 8 or more, and more preferably 10 or more. As the upper limit, aliphatic hydrocarbon compounds preferably having 40 or less, more preferably 20 or less, and further preferably 16 or less carbon atoms are mentioned.

Examples of the aliphatic hydrocarbon compound that is preferably used as the high-boiling-point liquid solvent include aliphatic hydrocarbon compounds, such as octane, 2-ethylhexane, decane, undecane, dodecane, and tridecane.

One of the high-boiling-point liquid media mentioned above may be used alone or two or more thereof may be used in combination.

Specific examples of the gas medium include inert gases, such as nitrogen and argon. Hydrogen sulfide or a mixture of hydrogen sulfide and an inert gas can also be used.

### (Heating)

In the production method of this embodiment, the medium is heated to a temperature higher than the boiling points of the first solvent and the second solvent.

Here, in the case where each of the first solvent and the second solvent is a mixture of a plurality of components, the boiling point of each solvent refers to the boiling point of a component that has the highest boiling point in the components contained in the solvent. However, the boiling point of a miner component that is contained at a ratio of 3% by mass or less in the solvent is not taken into account.

The medium is preferably heated to a temperature 20° C. or higher than the boiling points of the first solvent and the second solvent, more preferably heated to a temperature 40° C. or higher than those, and further preferably heated to a temperature 60° C. or higher than those.

The specific temperature to which the medium is to be heated in the case where the medium is liquid, from the viewpoint of efficiently vaporizing the solvents while suppressing degradation of the precursor, preferably 120° C. or higher and 500° C. or lower, more preferably 150° C. or higher and 450° C. or lower, and further preferably 170° C. or higher and 400° C. or lower.

The specific temperature to which the medium is to be heated in the case where the medium is gas, for the same reason as above, preferably 120° C. or higher and 700° C. or lower, more preferably 150° C. or higher and 600° C. or lower, and further preferably 170° C. or higher and 500° C. or lower.

The pressure condition in supplying the emulsion into the heated medium is not particularly limited, but from the viewpoint of efficiently removing the solvents, the condition under a normal pressure or a reduced pressure is preferred.

### (Method of Supply)

Specific examples of the method for supplying the emulsion into the medium in the aspect (2) collective removal include methods by injection, dropwise addition, or spraying. From the viewpoint of refining the particles of the resulting sulfide solid electrolyte, it is preferred to reduce the amount of the precursor contained in a droplet, and thus, it is preferred to dropwise add or spray the precursor-containing matter to supply it to the medium. More specific examples include a method by injection or dropwise addition with a tube pump and a method by spraying with a micro-spray.

Here, for refining the particles of the solid electrolyte and making the solid electrolyte uniform, the precursor-containing mixture is preferably supplied portionwise in a fixed small amount. The amount supplied can be appropriately adjusted depending on the medium used and the temperature. When the precursor-containing mixture is dropwise added to the medium, for example, the amount is preferably about 0.1 to 10 liter/minute for each supply port.

### (Heat Treatment)

In the production method of this embodiment, the sulfide solid electrolyte obtained as above can be used as it is, but the production method may further include subjecting the sulfide solid electrolyte to a heat treatment. By subjecting the sulfide solid electrolyte obtained as above to a heat treatment, a crystal structure is formed or the crystallinity thereof is increased, thus resulting in a high-quality sulfide solid electrolyte.

The heating temperature in the heat treatment is generally preferably 130° C. or higher, more preferably 140° C. or higher, and further preferably 150° C. or higher. The upper limit thereof is preferably 700° C. or lower, more preferably 600° C. or lower, and further preferably 500° C. or lower. The heating temperature means the highest temperature in the heat treatment.

The time period of the heat treatment can be appropriately adjusted depending on the apparatus used and the amount, but is generally 1 minute to 24 hours, preferably 10 minutes to 20 hours, more preferably 30 minutes to 16 hours, and further preferably 1 hour to 12 hours. The time period of the heat treatment means the time period in which the heating temperature by the heat treatment is kept.

The method of the heat treatment is not particularly limited. Examples thereof include a method using a vacuum heating apparatus and a method using a kiln. In an industrial method, a roller hearth kiln, a rotary kiln, and the like which include a heating means and a feeding mechanism can be used and may be selected depending on the amount to be heat-treated.

### (Amorphous Sulfide Solid Electrolyte)

The sulfide solid electrolyte obtained by the production method of this embodiment is either of an amorphous sulfide solid electrolyte or a crystalline sulfide solid electrolyte.

The amorphous sulfide solid electrolyte obtained by the production method of this embodiment contains a lithium atom, a sulfur atom, and a phosphorus atom, preferably contains a lithium atom, a sulfur atom, a phosphorus atom, and a halogen atom. Typical preferred examples thereof include solid electrolytes composed of lithium sulfide, a phosphorus sulfide, and a lithium halide, such as Li₂S—P₂S₅—LiI, Li₂S—P₂S₅—LiCl, Li₂S—P₂S₅—LiBr, and Li₂S—P₂S₅—LiI—LiBr; and solid electrolytes further containing other atoms, for example, an oxygen atom and a silicon atom, such as Li₂S—P₂S₅—Li₂O—LiI and Li₂S—SiS₂—P₂S₅—LiI. From the viewpoint of attaining a higher ionic conductivity, amorphous sulfide solid electrolytes composed of sulfide lithium, phosphorus sulfide, and a lithium halide, such as Li₂S—P₂S₅—LiI, Li₂S—P₂S₅—LiCl, Li₂S—P₂S₅—LiBr, and Li₂S—P₂S₅—LiI—LiBr are preferred.

The kinds of the atoms constituting the amorphous solid electrolyte can be found, for example, by ICP emission spectrophotometer.

### (Crystalline Sulfide Solid Electrolyte)

The crystalline sulfide solid electrolyte obtained by the production method of this embodiment may be a so-called glass ceramic which is obtained by heating an amorphous sulfide solid electrolyte to the crystallization temperature or higher. Examples of the crystal structure thereof include an Li₃PS₄ crystal structure, an Li₄P₂S₆ crystal structure, an Li₇PS₆ crystal structure, an Li₇P₃S₁₁ crystal structure, and a crystal structure having a peak in the vicinity of 2θ=20.2° and 23.6° (for example, JP 2013-16423 A).

Examples thereof also include an Li₄₋ₓGe₁₋ₓPₓS₄-based thio-LISICON Region II-type crystal structure (see Kanno, et al., Journal of The Electrochemical Society, 148(7)A 742-746 (2001)) and a crystal structure similar to the Li₄₋ₓGe₁₋ₓPₓS₄-based thio-LISICON Region II-type (see Solid State Ionics, 177 (2006), 2721-2725). Among the foregoing crystal structures, the crystal structure of the crystalline sulfide solid electrolyte obtained by the method for producing a solid electrolyte of this embodiment is preferably a thio-LISICON Region II-type crystal structure in that a higher ionic conductivity can be attained. The “thio-LISICON Region II-type crystal structure” as used herein refers to either of the Li₄₋ₓGe₁₋ₓPₓS₄-based thio-LISICON Region II-type crystal structure or a crystal structure similar to the Li₄₋ₓGe₁₋ₓPₓS₄-based thio-LISICON Region II-type.

The crystalline sulfide solid electrolyte obtained by the production method of this embodiment may contain the thio-LISICON Region II-type crystal structure or may contain the thio-LISICON Region II-type crystal structure as a main crystal, but, from the viewpoint of attaining a higher ionic conductivity, preferably contains the thio-LISICON Region II-type crystal structure as a main crystal. In the description herein, “containing as a main crystal” means that the proportion of the subject crystal structure in the crystal structure is 80% or more, and the proportion is preferably 90% or more, and more preferably 95% or more. From the viewpoint of attaining a higher ionic conductivity, the crystalline sulfide solid electrolyte obtained by the production method of this embodiment preferably contains no crystalline Li₃PS₄ (β-Li₃PS₄).

In X-ray diffractometry using the CuKα line, the diffraction peaks of the Li₃PS₄ crystal structure appear, for example, at around 2θ=17.5°, 18.3°, 26.1°, 27.3°, and 30.0°, the diffraction peaks of the Li₄P₂S₆ crystal structure appear, for example, at around 2θ=16.9°, 27.1°, and 32.5°, the diffraction peaks of the Li₇PS₆ crystal structure appear, for example, at around 2θ=15.3°, 25.2°, 29.6°, and 31.0°, and the diffraction peaks of the Li₇P₃S₁₁ crystal structure appear, for example, at around 2θ=17.8°, 18.5°, 19.7°, 21.8°, 23.7°, 25.9°, 29.6°, and 30.0°. The diffraction peaks of the Li₄₋ₓGe₁₋ₓPₓS₄-based thio-LISICON Region II-type crystal structure appear, for example, at around 2θ=20.1°, 23.9°, and 29.5°, the diffraction peaks of the crystal structure similar to the Li₄₋ₓGe₁₋ₓPₓS₄-based thio-LISICON Region II-type appear, for example, at around 2θ=20.2° and 23.6°. The positions of the peaks may vary within the range of ±0.5°.

A crystalline sulfide solid electrolyte having an argyrodite-type crystal structure having the Li₇PS₆ structural backbone in which P is partially substituted with Si is also preferably exemplified.

Examples of the compositional formula of the argyrodite-type crystal structure include compositional formulae Li₇₋ₓP_{1-y}Si_{y}S₆ and Li₇₊ₓP_{1-y}Si_{y}S₆ (x is −0.6 to 0.6, y is 0.1 to 0.6). The argyrodite-type crystal structure represented by the compositional formulae is a cubic crystal or an orthorhombic crystal, preferably a cubic crystal, and has peaks mainly appearing at positions of 2θ=15.5°, 18.0°, 25.0°, 30.0°, 31.4°, 45.3°, 47.0°, and 52.0° in X-ray diffractometry using the CuKα line.

Another example of the compositional formula of the argyrodite-type crystal structure is a compositional formula Li_{7-x-2y}PS_{6-x-y}Clₓ (0.8≤x≤1.7, 0<y≤−0.25x+0.5). The argyrodite-type crystal structure represented by the compositional formula is preferably a cubic crystal and has peaks mainly appearing at positions of 2θ=15.5°, 18.0°, 25.0°, 30.0°, 31.4°, 45.3°, 47.0°, and 52.0° in X-ray diffractometry using the CuKα line.

Another example of the compositional formula of the argyrodite-type crystal structure is a compositional formula Li₇₋ₓPS₆₋ₓHaₓ (Ha is Cl or Br, x is preferably 0.2 to 1.8). The argyrodite-type crystal structure represented by the compositional formula is preferably a cubic crystal and has peaks mainly appearing at position of 2θ=15.5°, 18.0°, 25.0°, 30.0°, 31.4°, 45.3°, 47.0°, and 52.0° in X-ray diffractometry using the CuKα line.

The positions of the peaks may vary within the range of ±0.5°.

### (Properties of Sulfide Solid Electrolyte)

The form of the sulfide solid electrolyte obtained by the production method of this embodiment is a particle form.

The average particle diameter (D₅₀) of the sulfide solid electrolyte in a particle form is, for example, 0.01 μm or more, furthermore, 0.03 μm or more, 0.05 μm or more, 0.1 μm or more. The upper limit thereof is preferably 15 μm or less, more preferably 9.0 μm or less, and further preferably 4.0 μm or less. Thus, the average particle diameter of the sulfide solid electrolyte obtained by the production method of this embodiment becomes so small as in the above range by making the ratio of the raw material-containing matter and the solvents into a certain value or less.

Accordingly, in the production method of this embodiment, it is not required to perform a grinding (grain refinement) treatment.

Similarly, the particle diameter at a cumulative volume of 10% (D₁₀) of the sulfide solid electrolyte is preferably 0.05 μm or more and 10.0 μm or less, more preferably 0.50 μm or more and 6.0 μm or less, and further preferably 1.0 μm or more and 3.0 μm or less.

The particle diameter at a cumulative volume of 90% (D₉₀) of the sulfide solid electrolyte is preferably 0.10 μm or more 20.0 μm or less, more preferably 1.0 μm or more and 15.0 μm or less, and further preferably 2.5 μm or more and 8.0 μm or less.

### (Application)

Since the sulfide solid electrolyte obtained by the production method of this embodiment is superior in the coating applicability and can be supplied to production of a battery even without a solvent and the like, the sulfide solid electrolyte can efficiently exhibit superior battery performance. In addition, the sulfide solid electrolyte provides a high ionic conductivity and a superior battery performance, and thus, can be suitably used for a battery.

The sulfide solid electrolyte obtained by the production method of this embodiment may be used in a positive layer, may be used in a negative layer, or may be used in an electrolyte layer. Each of the layers can be produced by a known method.

In the battery, a collector is preferably used in addition to the positive electrode layer, the electrolyte layer, and the negative electrode layer, and as the collector, a known one can be used. For example, a layer in which a metal that reacts with the solid electrolyte, such as Au, Pt, Al, Ti, or Cu, is coated with Au or the like can be used.

### EXAMPLES

Next, the present invention is specifically described with reference to examples, but the present invention is not to be limited to the examples.

### (Measurement of Particle Diameter Distribution)

The particle diameter at a cumulative volume of 10% (D₁₀), the average particle diameter (D₅₀), and the particle diameter at a cumulative volume of 90% (D₉₀) are determined with a particle diameter distribution cumulative curve obtained as follows.

Measurement was performed using a laser diffraction-scattering particle diameter distribution analyzer (“Partica LA-950 (model number)”, manufactured by HORIBA, Ltd.). Specifically, a powder to be measured was added into a flow cell of the analyzer and was subjected to an ultrasonic treatment, followed by measurement of the particle diameter distribution.

A cumulative curve of the particle diameter distribution was drawn, and the particle diameter at which the cumulative amount from the side of the particle having the minimum particle diameter reaches 50% (by volume) of the total was read as the average particle diameter (D₅₀).

### (Measurement of Ionic Conductivity)

The powder of each sulfide solid electrolyte obtained in Examples and Comparative Example was molded into a circular palette having a diameter of 6 to 10 mm (sectional area S: 0.283 to 0.785 cm²) and a height (L) of 0.1 to 0.3 cm to produce a specimen. Electrode terminals were attached to the specimen from above and below, and measurement was performed by an alternating current impedance method at 25° C. (frequency range: 1 MHz to 0.1 Hz, amplitude: 10 mV) to provide a Cole-Cole plot. The real part Z′ (Ω) at the point at which −Z″ (Ω) became the minimum near the right end of an arc observed in a region on the high frequency side was designated as the bulk resistance R (Ω) of the electrolyte, and the ionic conductivity a (S/cm) was calculated according to the following expressions.

R=ρ(L/S)

σ=1/ρ

### Example 1

In an anaerobic glove box, 0.597 g of lithium sulfide, 0.759 g of diphosphorus pentasulfide, 0.289 g of lithium chloride, and 0.356 g of lithium bromide were weighed, and 10 mL of tetrahydrofuran (THF) was added and the mixture was stirred for 12 hours. To the mixture, 40 mL of ethanol was further added to obtain a precursor-containing mixture. (The ratio of the raw material-containing matter and the solvents: 4.0 g of raw material-containing matter relative to 100 mL of the solvents)

To the precursor-containing mixture, 40 mL of tridecane was added, and the mixture was stirred at a low speed (stirring power: 0.017 W/m³) to obtain an emulsion.

The resulting emulsion was subjected to a vacuum drying treatment while stirring at a stirring power of 0.017 W/m³ at a room temperature for 4 hours, followed by a vacuum drying treatment at 50° C. for 2 hours, to remove ethanol, thus obtaining a slurry constituted of tridecane and a solid.

The solid was separated from the slurry by decantation. A washing operation in which toluene was added to the separated solid and decantation was then performed again to separate the solid was performed three times. Subsequently, vacuum drying was performed at 150° C. to collect a solid (sulfide solid electrolyte).

The particle diameter distribution of the collected solid was checked. Then, the particle diameter at a cumulative volume of 10% (D₁₀) was 4.5 μm, the average particle diameter (D₅₀) was 8.3 μm, and the particle diameter at a cumulative volume of 90% (D₉₀) was 12.4 μm.

The resulting solid was subjected to a heat treatment at 430° C. for 8 hours.

The ionic conductivity of the resulting sulfide solid electrolyte was measured, and then, the ionic conductivity was 4.3 mS/cm.

### Example 2

A sulfide solid electrolyte was obtained in the same manner as in Example 1 except for changing the stirring power in forming the emulsion (from adding tridecane to the precursor-containing mixture to removing ethanol to obtain a slurry) to 19 W/m³ to obtain the emulsion.

The particle diameter distribution of the collected solid showed a particle diameter at a cumulative volume of 10% (D₁₀) of 1.8 μm, an average particle diameter (D₅₀) of 3.2 μm, and a particle diameter at a cumulative volume of 90% (D₉₀) of 5.5 μm.

The resulting solid was subjected to a heat treatment at 430° C. for 8 hours.

The ionic conductivity of the resulting sulfide solid electrolyte was measured, and then, the ionic conductivity was 4.2 mS/cm.

### Example 3

A solid was collected in the same manner as in Example 2 except for reversing the order of the addition of ethanol and tridecane. Then, the particle diameter distribution of the collected solid showed a particle diameter at a cumulative volume of 10% (D₁₀) of 1.8 μm, an average particle diameter (D₅₀) of 3.2 μm, and a particle diameter at a cumulative volume of 90% (D₉₀) of 5.5 μm.

The ionic conductivity of the sulfide solid electrolyte subsequently obtained in the same manner as in Example 2 was measured, and then, the ionic conductivity was 4.2 mS/cm.

### Comparative Example 1

A sulfide solid electrolyte was obtained in the same manner as in Example 1 except for subjecting the precursor-containing mixture to vacuum drying at 150° C. as it was without addition of tridecane thereto to obtain the sulfide solid electrolyte.

The particle diameter distribution of the collected solid showed a particle diameter at a cumulative volume of 10% (D₁₀) of 3.8 μm, an average particle diameter (D₅₀) of 188.0 μm, and a particle diameter at a cumulative volume of 90% (D₉₀) of 355.1 μm.

The resulting solid was subjected to a heat treatment at 430° C. for 8 hours.

The ionic conductivity of the resulting sulfide solid electrolyte was measured, and then, the ionic conductivity was 4.4 mS/cm.

The stirring power in stirring the precursor-containing mixture and tridecane and the properties of the resulting sulfide solid electrolyte in Examples 1 to 3 and Comparative Example 1 are shown in Table 1.

TABLE 1

| | | Properties of sulfide solid electrolyte | | | |
|---|---|---|---|---|---|
| | | Particle | | Particle | |
| | | diameter at | Average | diameter at | Ion |
| | | cumulative | particle | cumulative | conduc- |
| | Stirring | volume of | diameter | volume of | tivity |
| | power | 10% (D₁₀) | (D₅₀) | 90% (D₉₀) | [mS/ |
| | [W/m³] | [μm] | [μm] | [μm] | cm] |
| Example 1 | 0.017 | 4.5 | 8.3 | 12.4 | 4.3 |
| Example 2 | 19 | 1.8 | 3.2 | 5.5 | 4.2 |
| Example 3 | 19 | 1.8 | 3.2 | 5.5 | 4.2 |
| Comparative | — | 3.8 | 188.0 | 355.1 | 4.4 |
| Example 1 | | | | | |

As is apparent from the comparison between Examples 1 to 3 and Comparative Example 1, in Examples 1 to 3 in which the precursor-containing mixture was mixed with ethanol and tridecane to obtain an emulsion, the resulting sulfide solid electrolyte had smaller particle diameters (D₁₀, D₅₀, D₉₀).

### INDUSTRIAL APPLICABILITY

The sulfide solid electrolyte obtained by the production method of this embodiment is suitably used for batteries that are used in information-related apparatuses and communication apparatuses, such as personal computers, video cameras, and cell phones.

1. A method for producing a sulfide solid electrolyte, the method comprising
mixing a raw material-containing matter that contains a lithium atom, a phosphorus atom, and a sulfur atom with a first solvent to provide a precursor-containing mixture,
mixing the precursor-containing mixture with a second solvent that is incompatible with the first solvent to provide an emulsion, and
removing the first solvent and the second solvent from the emulsion.

2. The method for producing a sulfide solid electrolyte according to claim 1, wherein one of the first solvent and the second solvent contains an alcohol solvent and the other of the first solvent and the second solvent contains a hydrocarbon solvent having 5 to 40 carbon atoms.

3. The method for producing a sulfide solid electrolyte according to claim 1, wherein the first solvent contains a hydrocarbon solvent having 5 to 40 carbon atoms and the second solvent contains an alcohol solvent.

4. The method for producing a sulfide solid electrolyte according to claim 1, wherein the first solvent and the second solvent are removed from the emulsion by
removing one of the first solvent and the second solvent from the emulsion to provide a slurry containing the sulfide solid electrolyte, and
removing the other of the first solvent and the second solvent from the slurry.

5. The method for producing a sulfide solid electrolyte according to claim 1, wherein the first solvent and the second solvent are removed from the emulsion by
supplying the emulsion into a liquid or gas medium of a temperature higher than a boiling point of the first solvent and higher than a boiling point of the second solvent to vaporize the first solvent and the second solvent.

6. The method for producing a sulfide solid electrolyte according to claim 1, wherein the first solvent contains a complexing agent.

7. The method for producing a sulfide solid electrolyte according to claim 1, wherein the raw material-containing matter further contains a halogen atom.

8. The method for producing a sulfide solid electrolyte according to claim 1, the method further comprising, after removing the first solvent and the second solvent from the emulsion,
subjecting the sulfide solid electrolyte to a heat treatment to crystallize the sulfide solid electrolyte.

9. The method for producing a sulfide solid electrolyte according to claim 1, wherein the first solvent and the second solvent are used at a ratio of 10:90 to 90:10 by mass.

10. The method for producing a sulfide solid electrolyte according to claim 1, wherein the raw material-containing matter and the first solvent are used at a ratio of 1.0 g or more and 20.0 g or less of the raw material-containing matter relative to 100 ml of the first solvent.

11. The method for producing a sulfide solid electrolyte according to claim 1, wherein the precursor-containing mixture and the second solvent are mixed at a stirring power of 0.01 W/m³ or more.
